(19) United States
(12) Patent Application Publication
(10) Pub. No.: US 2024/0007197 A1
(43) Pub. Date: Jan. 4, 2024

(54) UNDERWATER WIRELESS COMMUNICATION NETWORK

(71) Applicant: KING ABDULLAH UNIVERSITY OF SCIENCE AND TECHNOLOGY, Thuwal (SA)

(72) Inventors: Meiwei KONG, Thuwal (SA); Boon S. OOI, Thuwal (SA); Tien Khee NG, Thuwal (SA)

(21) Appl. No.: 17/923,069

(22) PCT Filed: May 12, 2021
(86) PCT No.: PCT/IB2021/054060

§ 371 Date: Nov. 3, 2022

Related U.S. Application Data
(60) Provisional application No. 63/023,458, filed on May 12, 2020.

(51) Int. Cl. H04B 10/80; G01S 15/88; H04B 10/27

(52) U.S. Cl. CPC H04B 10/807; G01S 15/88; H04B 10/27; H04B 2210/006

(57) ABSTRACT

An underwater wireless communication network includes a first buoyant platform, including a radio-frequency communication transceiver and a wired communication transceiver, floating at a surface of a body of water. A first underwater sensor node is coupled to the first buoyant platform by at least one wire over which the first buoyant platform and the first underwater sensor node communicate. The first underwater sensor includes a wired communication transceiver to communicate with the first buoyant platform over the at least one wire. The first buoyant platform or the first underwater sensor node includes a first ambient energy collector configured to power the first buoyant platform or the first underwater sensor node. A second underwater sensor node, arranged under the body of water, includes a second ambient energy collector configured to power the second underwater sensor node. The first and second underwater sensor nodes each comprise a sensor, an optical communication transceiver, and an acoustic positioning system.

### CROSS-REFERENCE TO RELATED APPLICATIONS

This application claims priority to U.S. Provisional Patent Application No. 63/023,458, filed on May 12, 2020, entitled “UNDERWATER WIRELESS SENSOR NETWORK AND METHOD BASED ON OPTICAL WIRELESS COMMUNICATION TECHNOLOGY,” the disclosure of which is incorporated herein by reference in its entirety.

### BACKGROUND

### Technical Field

Embodiments of the disclosed subject matter generally relate to an autonomous underwater wireless communication network that uses optical communication among self-powered underwater sensor nodes to collect sensor data.

### Discussion of the Background

Recently there has been great attention to the research and development of underwater wireless sensor networks for marine environmental monitoring, offshore exploration, tsunami warning, etc. These underwater wireless sensor networks typically include a large number of underwater sensor nodes that form a self-organized network and communicate using acoustic communications, which is the most mature technology for underwater communication. Underwater acoustic communications suffer from a number of deficiencies. First, the acoustic signals experience significant multipath effects because the propagated sounds waves may be affected by the refraction of layered media in the water and the reflection off of the sea surface and seabed. Second, underwater acoustic has a slow propagation speed (˜1500 m/s) and a large transmission latency on the order of milliseconds. Further, the propagation speed of sound waves in water varies with salinity, temperature, and pressure (depending on depth), which can result in dynamic changes in the transmission latency. Third, the amplitude and phase of received acoustic signals are easily distorted due to the multipath effect, transmission latency, background noise, and various dynamic factors (e.g., waves on the water surface of internal waves), which can cause inter-symbol interference and result in a high bit error rate. Fourth, underwater acoustic communications have a limited bandwidth because the higher the communication frequency, the greater absorption loss of the sound wave. Although it is possible to achieve a bandwidth of 100 kHz at a distance of less than 100 m, the bandwidth is typically less than 10 kHz at a transmission distance between 1 km and 10 km.

In view of the various issues with underwater acoustic communication, Reference Document [1] discloses an underwater multi-hop communication network that uses optical transceivers for both communication between nodes and identifying proximately located nodes. The multi-hop communication network is an ad-hoc network employing a time division multiple access (TDMA) medium access control (MAC) protocol. TDMA MAC protocols require the allocation of timeslots to different nodes to avoid two or more node transmission from interfering. Alternatively, a TDMA MAC protocol can allow multiple nodes to attempt to communication in a particular timeslot and provide a contention resolution mechanism to address interfering communications between two nodes attempting to communication in a particular timeslot. Thus, the TDMA MAC protocols introduce an additional amount of processing for the nodes. Because the nodes are powered by a battery or fuel cell, this additional amount of processing increases the electrical load on each node, and thus requires more frequent visits to the underwater nodes to replace the battery or resupply fuel for the fuel cell.

Thus, there is a need for an underwater communication network that uses a form of wireless communication that does not experience similar limitations to acoustic communications.

### SUMMARY

According to embodiments, there is an underwater wireless communication network, which includes a first buoyant platform floating at a surface of a body of water and comprising a radio-frequency communication transceiver and a wired communication transceiver. A first underwater sensor node is coupled to the first buoyant platform by at least one wire over which the first buoyant platform and the first underwater sensor node communicate. The first underwater sensor includes a wired communication transceiver to communicate with the first buoyant platform over the at least one wire. The first buoyant platform or the first underwater sensor node includes a first ambient energy collector configured to power the first buoyant platform or the first underwater sensor node. A second underwater sensor node is arranged under the body of water and comprises a second ambient energy collector configured to power the second underwater sensor node. The first and second underwater sensor nodes each comprise a sensor, an optical communication transceiver, and an acoustic positioning system.

According to embodiments, there is a method for communicating using an underwater wireless communication network. An acoustic positioning system is used to determine that a first underwater sensor node is within optical communication range of a second underwater sensor node. Responsive to the determination that the first underwater sensor node is within optical communication range of the second underwater sensor node, an optical communication connection is established between a first optical transceiver of the first underwater sensor node and a second optical transceiver of the second underwater sensor node. Sensor data collected by a second sensor of the second underwater sensor node is transmitted to the first underwater sensor node over the established optical communication connection. The first underwater sensor node transmits sensor data collected by a first sensor of the first underwater sensor node and the sensor data collected by the second sensor node to a first buoyant platform floating at a surface of a body of water over a wired connection using a wired transceiver of the first underwater sensor node and a wired transceiver of the first buoyant platform. A radio-frequency transceiver of the first buoyant platform transmits the sensor data collected by the first and second sensors to a land-based radio-frequency base station.

According to embodiments, there is a method for communicating using an underwater wireless communication network comprising first and second underwater sensor nodes respectively comprising first and second optical transceivers. An acoustic positioning system of an underwater vehicle is used to determine that the underwater vehicle is within optical communication range of the second sensor node. Responsive to the determination that the second underwater sensor node is within optical communication range of the underwater vehicle, an optical communication connection is established between the second optical transceiver of the second underwater sensor node and an optical transceiver of the underwater vehicle. Sensor data collected by a second sensor of the second underwater sensor node is transmitted to the underwater vehicle over the established optical communication connection. The acoustic positioning system of the underwater vehicle is used to determine that the underwater vehicle is within optical communication range of the first underwater sensor node. Responsive to the determination that the underwater vehicle is within optical communication range of the first underwater sensor node, an optical communication connection is established between the first optical transceiver of the first underwater sensor node and the optical transceiver of the underwater vehicle. The underwater vehicle transmits sensor data collected by the second sensor of the second underwater sensor node to the first underwater sensor node over the established optical communication connection. The first underwater sensor node transmits sensor data collected by a first sensor of the first sensor node and the sensor data collected by the second sensor node to a first buoyant platform floating at a surface of a body of water over a wired connection using a wired transceiver of the first underwater sensor node and a wired transceiver of the first buoyant platform. A radio-frequency transceiver of the first buoyant platform transmits the sensor data collected by the first and second sensors to a land-based radio-frequency base station.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-1D are schematic diagrams of underwater wireless communication networks according to embodiments;

FIG. 2A is a block diagram of a buoyant platform according to embodiments;

FIG. 2B is a block diagram of a first underwater sensor node according to embodiments;

FIG. 2C is a block diagram of a second underwater sensor node according to embodiments;

FIG. 2D is a block diagram of an underwater vehicle according to embodiments;

FIG. 2E is another block diagram of an underwater sensor node according to embodiments; and

FIGS. 3A, 3B, 4A, and 4B are flowchart of methods for communicating using an underwater wireless communication network.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of wireless underwater communication networks that use optical communications between nodes.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

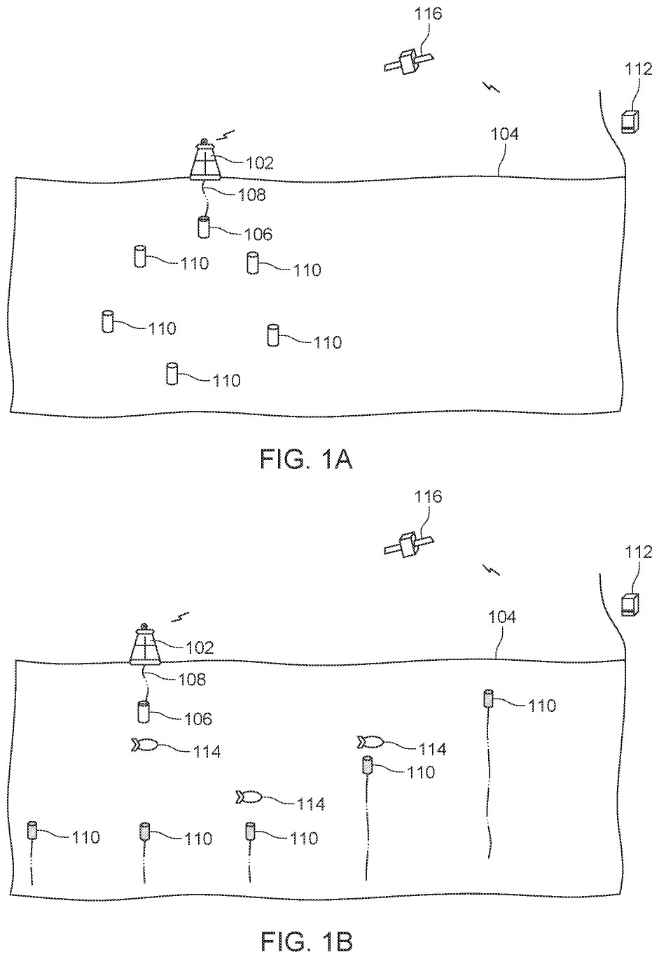

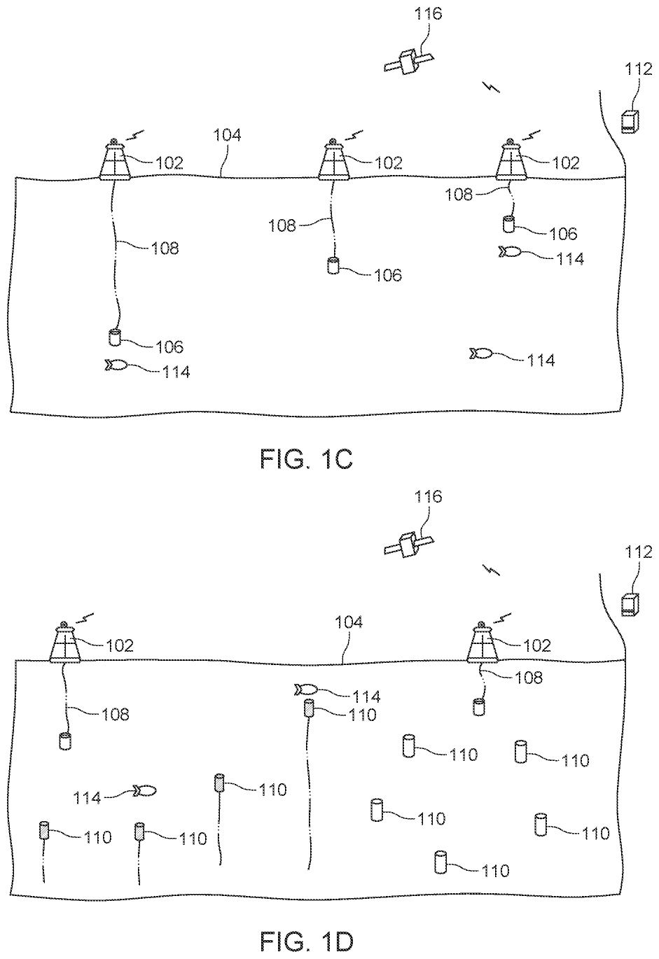

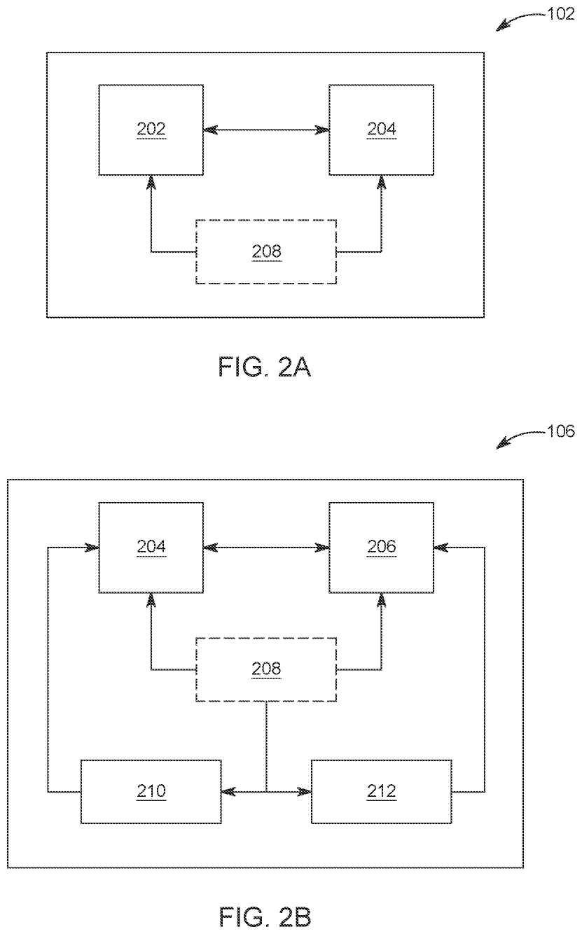

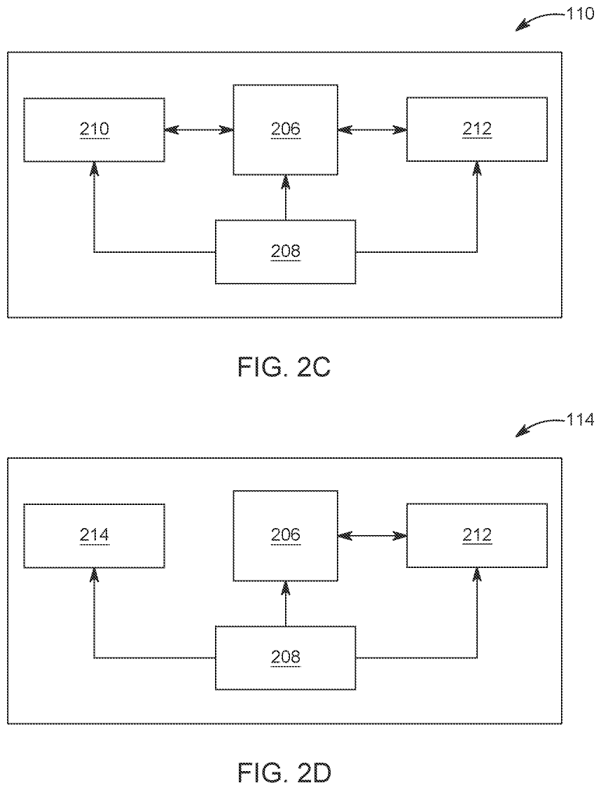

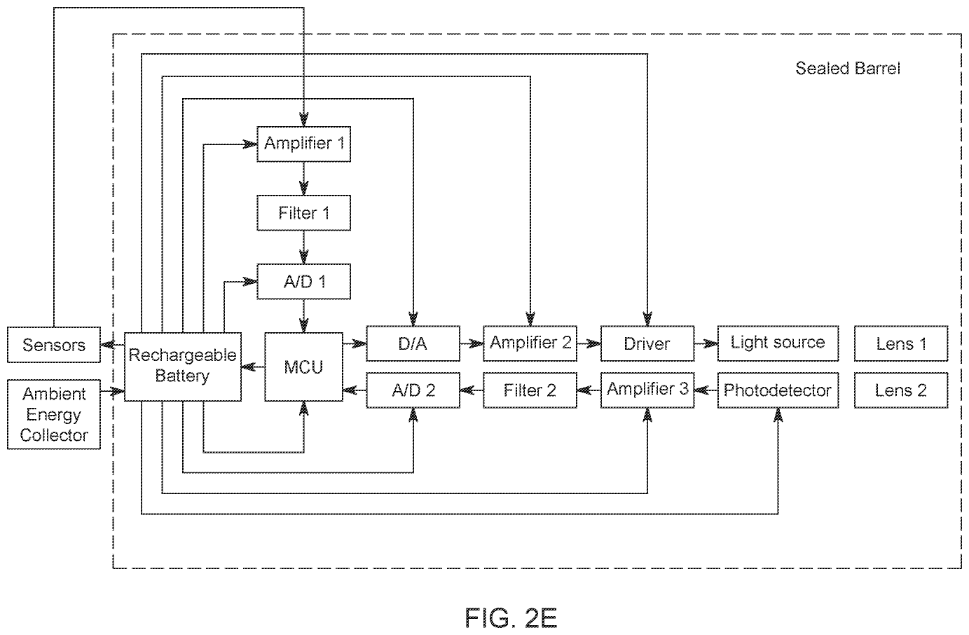

FIGS. 1A-1D and FIGS. 2A-2D illustrate underwater wireless communication networks and the components of such networks. The underwater wireless communication networks include a first buoyant platform 102 floating at a surface of a body of water 104 and comprising a radio-frequency communication transceiver 202 and a wired communication transceiver 204. The networks also include a first underwater sensor node 106 coupled to the first buoyant platform 102 by at least one wire 108 over which the first buoyant platform 102 and the first underwater sensor node 106 communicate. The first underwater sensor 106 includes a wired communication transceiver 204 to communicate with the first buoyant platform 102 over the at least one wire 108. The first buoyant platform 102 or the first underwater sensor node 106 includes a first ambient energy collector 208 configured to power the first buoyant platform 102 and/or the first underwater sensor node 106. The networks also include a second underwater sensor node 110 under the body of water 104 and comprising a second ambient energy collector 208 configured to power the second underwater sensor node 110. The first 106 and second 110 underwater sensor nodes each comprise a sensor 210, an optical communication transceiver 206, and an acoustic positioning system 212.

As illustrated in FIGS. 1A-1D, the first buoyant platform 102 can use the radio-frequency communication transceiver 202 to communicate either directly with a land-based radio-frequency base station 112 or via a communications satellite 116. The radio-frequency transceivers 202 can employ any type of wireless communication frequencies and any type of wireless communication protocol.

Referring specifically to FIG. 1A, this underwater wireless communication network includes one first underwater wireless communication sensor node 106 coupled to one first buoyant platform 102 and a plurality of second underwater sensor nodes 110. The plurality of second underwater sensor nodes 110 can be arranged at the same of different depths under the water 104. The nodes 110 in FIG. 1A are deployed as floating collaborating-nodes (i.e., sometimes referred to in the art as swarm nodes) moving according to the ocean current, while the nodes 110 in FIG. 1B are anchored nodes for permanent parametric monitoring. In the network of FIG. 1A, any second underwater sensor node 110 nodes within optical communication range of the first underwater sensor node 102 can communicate directly with each other, e.g., sending sensor data to the first sensor node and transmitting control data to second underwater sensor nodes 110. If only one of the second underwater sensor nodes 110 is within optical communication range of the first underwater sensor node, or if desired to be implemented when more than one of the second underwater sensor nodes 110 is within optical communication range of the first underwater sensor node 106, the second sensor nodes 110 can transmit to another one of the second sensor nodes 110 within optical communication range, which can be repeated until the communication is transmitted to the first underwater sensor node 106. As used herein, being within optical communication range should be understood as being close enough so that there is sufficient bandwidth for communicating sensor data and control data within the network. Thus, even if an optical beam can reach another one of the underwater sensor nodes, if the bandwidth of the communication connection is insufficient to communicate sensor data and control data, then the two underwater sensor nodes are not within optical communication range of each other. The various disclosed components can employ any type of communication and routing protocol consistent with the disclosed operation of the underwater wireless communication network.

Turning now to FIG. 1B, this network uses one or more underwater vehicles 114 to convey communications between the first underwater sensor node 106 and any one or more of the second underwater sensor nodes 110. The second underwater sensor nodes 110 are fixed to the floor of the body of water 104 and can be arranged at the same or different depths. The underwater vehicles 114 can be manned, autonomous, or remote-controlled underwater vehicles or collaborating as swarm-nodes. A non-limiting example of an underwater vehicle is an underwater glider. The collection of sensor data (i.e., readings or measurements by the sensors) can be performed in several different ways in this network. Second underwater sensor nodes 110 can transmit sensor data to another one of the second sensor nodes 110 that is within optical communication range. For example, one of the second underwater sensor nodes 110 can collect sensor data from one or more of the other second underwater sensor nodes 110, which can be collected using a direct transmission or be passed from one of the second underwater sensor nodes 110 to another until a collection of sensor data is received by a designated second underwater sensor node 110. An underwater vehicle can periodically travel between the designated underwater sensor node 110 to obtain the collected sensor data and then travel to the first underwater sensor node 106 to then transmit the collected sensor data. This can involve, for example an autonomous underwater vehicle 114 following a defined path between the first and second underwater sensor nodes to collect sensor data, as well as distribute control data.

The network illustrated in FIG. 1B includes a plurality of underwater vehicles 114. In this case, the underwater vehicle 114 on the lower left side of the figure can collect sensor data from the three second underwater sensor nodes on the left side of the figure, the underwater vehicle on the middle of the figure can collect sensor data from the two second underwater sensor nodes 110 on the right side of the figure, and these two underwater vehicles 114 can then pass the collected sensor data to the upper-most underwater vehicle 114 in the figure, which then conveys the collected sensor data from both underwater vehicles 114 (and the five second underwater sensor nodes 110) to the first underwater sensor node 106. Further, control data can be transmitted from land-based radio-frequency base station 112, which control data can be distributed using the routing described above in the opposite direction.

Although FIG. 1B illustrates a plurality of underwater vehicles, the network can be implemented with more or fewer underwater vehicles depending upon the size of underwater wireless communication network and the communication delay tolerable by the network. The shorter the communication delay, the fewer underwater vehicles are required.

Turning now to FIG. 1C, this network includes a plurality of first buoyant platforms 102 and a plurality of first underwater sensor nodes 106, as well as one or more underwater vehicles 114. In this network the underwater vehicles collect sensor data from one or more of the first underwater sensor nodes 106 and then transmits the collected sensor data to a particular one of the first underwater sensor nodes 106 that is designated as the sink node, which then provides the collected sensor data to the associated first buoyant platform 102, which then transmits the collected sensor data using radio-frequency communications to the land-based radio-frequency base station 112, either directly or via satellite 116. The communication of control data can follow the opposite path.

This network can be implemented so that only one of the buoyant platforms is a first buoyant platform 102 with both a radio-frequency transceiver 202 and a wired communication transceiver 204, whereas the remaining buoyant platforms do not have these transceivers. In this case, the first buoyant platform 102 with the radio-frequency transceiver 202 can be a sink node that collects sensor data from the other first buoyant platforms that do not have a radio-frequency transceiver 202 and communicates with land-based radio-frequency base station 112. Alternatively, more than one or all of the buoyant platforms can include both a radio-frequency transceiver 202 and a wired communication transceiver 204, and the sink node can stay the same or change. This can be advantageous, for example, when a satellite 116 is employed to communicate with the land-based radio-frequency base station 112 because it allows different ones of the first buoyant platforms to communicate with the satellite, depending upon the relative positions of the satellite 116 and the first buoyant platforms 102. It should be recognized that the term satellite should be understood as any airborne device or system capable of conveying communications, which can be within or outside of the earth's atmosphere and can include more than one satellite.

FIG. 1D illustrates how the networks of FIGS. 1A-1C can be combined. Thus, the second sensor nodes 110 illustrated on the left-hand side of the figure employ underwater vehicles 114 to convey communications between the first underwater sensor node 102 and the plurality of second underwater sensor nodes 110 similar to the discussion above in connection with FIGS. 1B and 1C, whereas the second sensor nodes 110 on the right-hand side of the figure communicate with each other until one or more of the second sensor nodes 110 conveys communications to (or receives communications from) the first underwater sensor node 106, similar to the discussion above in connection with FIG. 1A.

FIG. 2A is a block diagram of a first buoyant platform 102 according to embodiments. As illustrated, the first buoyant platform 102 includes a radio-frequency transceiver 202 coupled to a wired communication transceiver 204. The first buoyant platform 102 can also include an ambient energy collection device 208.

FIG. 2B is a block diagram of a first underwater sensor node 106 according to embodiments. The first underwater sensor node 106 includes wired transceiver 204 coupled to an optical communication transceiver 206. The first underwater sensor node 106 also includes a sensor 210 coupled to the wired transceiver 204 and an acoustic positioning system 212 coupled to the optical communication transceiver 206. The first underwater sensor node 106 can also include an ambient energy collection device 208 coupled to the transceivers 204 and 206, as well as the sensor 210 and acoustic positioning system 212. If the first underwater sensor node 106 does not include an ambient energy collection device 208, then the transceivers 204 and 206, the sensor 210, and acoustic positioning system 212 are coupled to a power line from the first buoyant platform 102. In one implementation, the components of the first underwater sensor node 106 other than the sensor 210 can be contained in a sealed barrel, with the sensor 210 be arranged external to the first underwater sensor node 106 so that it can measure parameters in the water.

FIG. 2C is a block diagram of a second underwater sensor node 110 according to embodiments. The second underwater sensor node 110 includes an optical communication transceiver 206 coupled to a sensor 210 and acoustic positioning system 212. An ambient energy collector 208 is coupled to the optical communication transceiver 206, sensor 210, and acoustic positioning system 212. In one implementation, the components of the second underwater sensor node 110 other than the sensor 210 can be contained in a sealed barrel, with the sensor 210 be arranged external to the second underwater sensor node 110 so that it can measure parameters in the water.

FIG. 2D is a block diagram of an underwater vehicle 114 according to embodiments. The underwater vehicle 114 includes an optical communication transceiver 206 coupled to an ambient energy collector 208 and an acoustic positioning system 212. The ambient energy collector 208 is also coupled to a drive 214, which moves the underwater vehicle 114 through the water. The drive 214 can be any type of drive used for traveling under water.

For ease of discussion, common reference numbers are used to refer to similar components in the first buoyant platform 102, the first underwater sensor node 106, the second underwater sensor node 110, and the underwater vehicle 114 because these components perform similar functions in the first buoyant platform 102, the first underwater sensor node 106, the second underwater sensor node 110, and the underwater vehicle 114. However, these similar components do not have to be identical components. For example, the optical communication transceiver 206 of the underwater vehicle 114 can employ more power or provide more sophisticated processing of optical communication signals compared to optical communication transceivers in the underwater sensor nodes.

The radio-frequency communication transceiver 202 can be any type of radio-frequency communication transceiver 202 capable of employing radio frequencies to communicate with the satellite 116 or the land-based radio-frequency base station 112. The wired communication transceivers 204 can be any type of transceiver capable of wired communications. The optical communication transceivers 206 can be any type of transceiver capable of optical communications. The ambient energy collection devices 208 can be any type of device that can collect ambient energy, such as a solar panel for collecting solar energy, or devices for collecting tidal or wave energy. Further, the ambient energy collection device can be an optical to electrical energy converter configured to convert optical energy from the optical communications with other elements of the network into electrical energy to power the particular element. For example, the underwater vehicle 114 can transmit an optical beam to one of the first 106 or second 110 underwater sensor nodes, the reception of which wakes-up the sensor node, which then converts a portion of the optical beam into electrical energy for operation of the sensor node.

The sensors 210 can sense one or more parameters, including, but not limited to, water temperature, salinity, dissolved oxygen concentration, ammonia nitrogen concentration, light intensity, pH value, etc. Each first 106 or second 110 underwater sensor nodes can include one or more of these types or similar sensors. It should be recognized that different ones of the first 106 or second 110 underwater sensor nodes can include different sensors or can include the same sensors. The acoustic positioning system 212 can be any type of acoustic positioning system, as such systems are well-known in the art.

Although not specifically illustrated, the first buoyant platform 102, the first underwater sensor nodes 106, the second underwater sensor nodes 110, and the underwater vehicle 114 can include a rechargeable battery for storing energy, as well as a processor and memory for controlling operation of the particular network element. The processor can be any type of processor, including a microprocessor, field programmable gate array (FPGA), or application specific integrated circuit (ASIC). The memory can be any type of memory capable of storing sensor data and computer-readable instructions for operating the particular network element.

FIG. 2E is another block diagram of first 106 or second 110 underwater sensor node according to embodiments. As illustrated, one or more sensors and an ambient energy collector are arranged outside of a sealed barrel that includes the remaining components. It should be recognized, however, that in certain implementations, such as when an underwater sensor node is powered by an incoming optical from another component in the network (described in more detail below), the ambient energy collector can be arranged inside of the sealed barrel. Further, the housing of the first and second ambient energy collectors do not need to be barrel-shaped and can have any desired shape.

In FIG. 2E, the amplifiers perform signal amplification, the filters remove the signal noise, and the analog-to-digital (ND) and digital to analog (D/A) converters convert signals between analog and digital. The microprocessor control unit (MCU) can be any type of processor, including a microprocessor, field programmable gate array (FPGA), application specific integrated circuit (ASIC), etc. Further, the MCU includes one or more memories for storing sensor data prior to transmission and for storing computer-readable instructions for the operation of the underwater sensor nodes, including monitoring battery power. The rechargeable battery is coupled to the ambient energy collector to recite electrical energy and distributes the collected electrical energy to the various components illustrated in FIG. 2E.

Sensor data from the one or more sensors pass through amplifier 1, filter 1, and ND converter 1 and then are passed to the MCU. MCU processes the sensor data, such as digital signal modulation, and then passes the processed sensor data to a D/A converter, which then passes the analog signal to amplifier 2. Amplifier 2 passes the analog signal to the driver, which controls the light source so that it operates in the linear range and modulates the analog electrical signals representing the sensor data onto the light beam produced by the light source. The light source is a signal transmitter for the modulated light beam. Two differently sized lens are provided (Lens 1 and Lens 2), which allow adjustability of the size of the transmitted and received light spot. Although two lens are illustrated, the underwater sensor node can include more or fewer lenses.

Incoming optical beams are received by the photodetector, via one of the lenses, which converts the received optical beam into electrical signals representing control data for the underwater sensor node. The control data is amplified by amplifier 3, filtered by filter 2, converted to digital signals by ND 2, and then provided to the MCU for processing. The control data can change the operation of the underwater sensor node, such as adjusting the operation of the sensors, adjusting the depth of the underwater sensor node, etc.

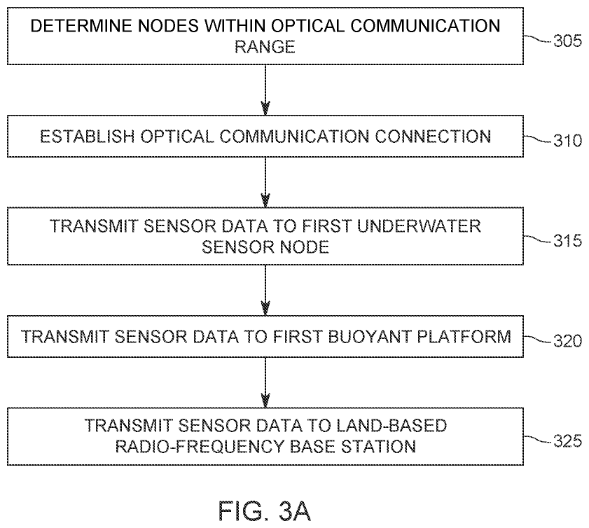

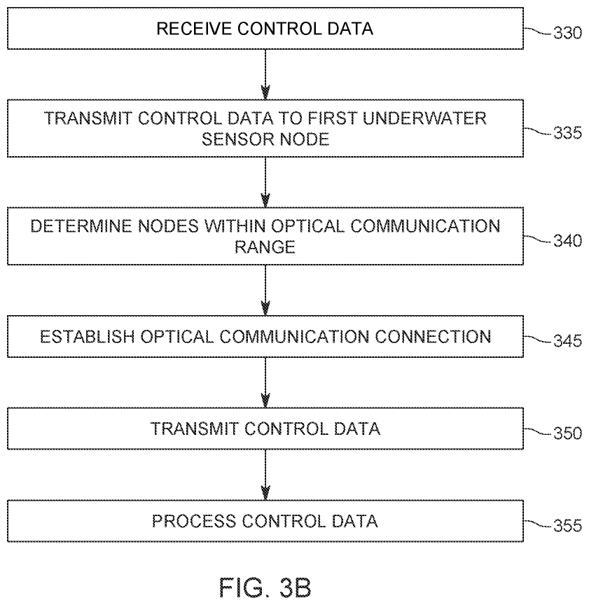

A method for communicating using an underwater wireless communication network will now be described in connection with FIGS. 3A and 3B with reference to FIGS. 1A-1D and FIGS. 2A-2D. Turning first to FIG. 3A, an acoustic positioning system 212 is used to determine that a first underwater sensor node 106 is within optical communication range of a second underwater sensor node 110 (step 305). An optical communication connection is established between a first optical transceiver 206 of the first underwater sensor node 106 and a second optical transceiver 206 of the second underwater sensor node 110 responsive to the determination that the first underwater sensor node 106 is within optical communication range of the second underwater sensor node 110 (step 310).

Sensor data collected by a second sensor 210 of the second underwater sensor node 110 is sent to the first underwater sensor node 106 over the established optical communication connection (step 315). The first underwater sensor node 106 transmits sensor data collected by a first sensor 210 of the first underwater sensor node 106 and the sensor data collected by the second sensor node 110 to a first buoyant platform 102 floating at a surface of a body of water 104 over a wired connection 108 using a wired transceiver 204 of the first underwater sensor node 106 and a wired transceiver 204 of the first buoyant platform 102 (step 320). A radio-frequency transceiver 202 of the first buoyant platform 102 transmits the sensor data collected by the first and second sensors 210 to a land-based radio-frequency base station 112 (step 325).

The communication of data from the land-based radio-frequency communication network 112 to the second underwater sensor node 110 will now be described in connection with FIG. 3B. The first buoyant platform 102 receives control data for the second underwater sensor node 110 from the land-based radio-frequency base station 112 (step 330). The wired transceiver 204 of the first buoyant platform 102 transmits the control data to the wired transceiver 204 of the first underwater sensor node 106 (step 335). The acoustic positioning system 212 is used to determine that the first underwater sensor node 106 is within optical communication range of the second underwater sensor node 110 (step 340). A further optical communication connection is established between the first 106 and second 110 underwater sensor nodes responsive to the determination that the first underwater sensor node 106 is within optical communication range of the second underwater sensor node 110 (step 345).

The first underwater sensor node 106 transmits the control data to the second underwater sensor node 110 over the established further optical communication connection (step 350). The second underwater sensor node 110 processes the control data and adjusts operation of the second underwater sensor node 110 based on the processed control data (step 355).

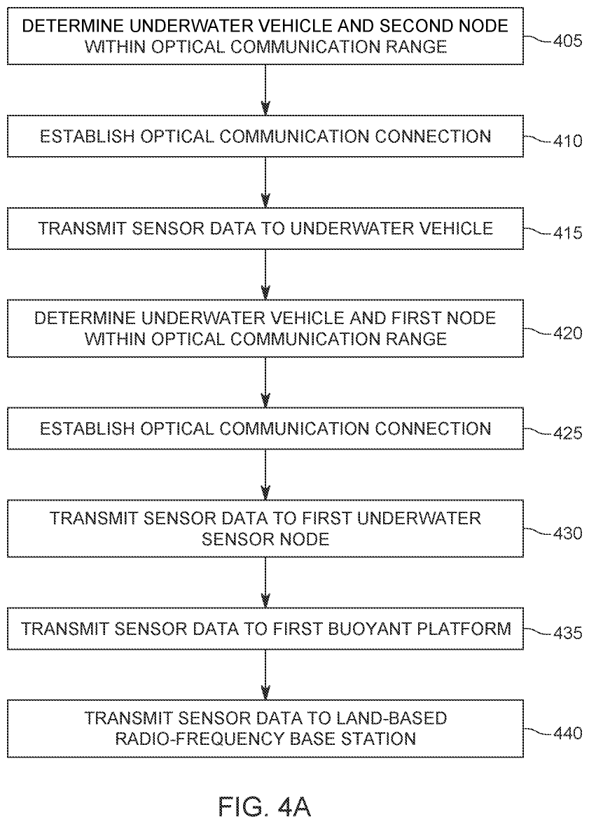

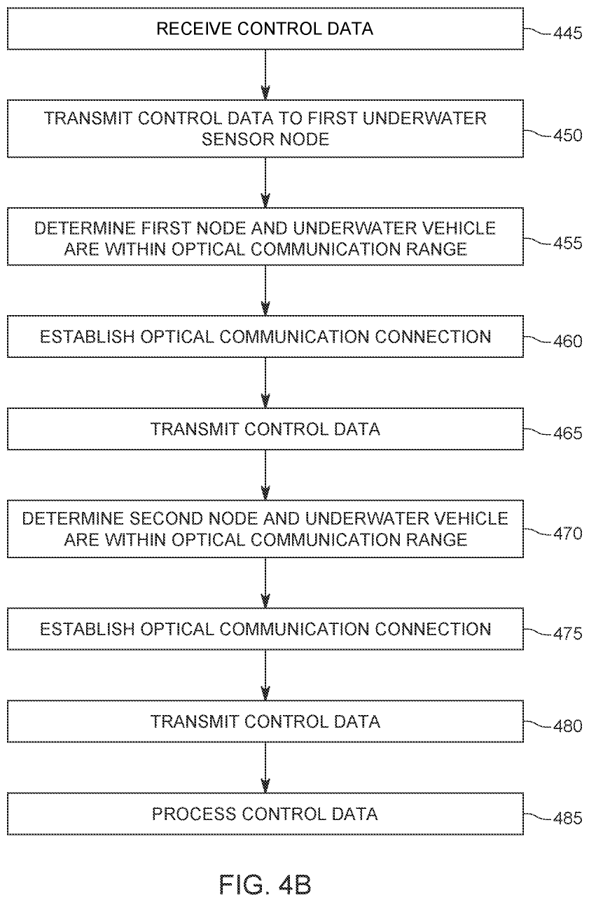

A method for communicating using an underwater wireless communication network will now be described in connection with FIGS. 4A and 4B, with reference to FIGS. 1A-1D and FIGS. 2A-2D. The underwater wireless communication network includes first 106 and second 110 underwater sensor nodes respectively comprising first and second optical transceivers 206. Turning first to FIG. 4A, an acoustic positioning system 212 of an underwater vehicle 114 is used to determine that the underwater vehicle 114 is within optical communication range of the second sensor node 110 (step 405). An optical communication connection is established between the second optical transceiver 206 of the second underwater sensor node 110 and an optical transceiver 206 of the underwater vehicle 114 responsive to the determination that the second underwater sensor node 110 is within optical communication range of the underwater vehicle 114 (step 410). Sensor data collected by a second sensor 210 of the second underwater sensor node 110 is transmitted to the underwater vehicle 114 over the established optical communication connection (step 415).

The acoustic positioning system 212 of the underwater vehicle 114 is used to determine that the underwater vehicle 114 is within optical communication range of the first underwater sensor node 106 (step 420). This can occur after the underwater vehicle 114 moves from a location within optical communication range of the second underwater sensor node 110 to a location within optical communication range of the first underwater sensor node 106 or the underwater vehicle can be located such that it is within optical communication range of both the first 106 and second 110 underwater sensor nodes.

An optical communication connection between the first optical transceiver 206 of the first underwater sensor node 106 and the optical transceiver 206 of the underwater vehicle 114 is established responsive to the determination that the underwater vehicle 114 is within optical communication range of the first underwater sensor node 106 (step 425). The underwater vehicle 114 transmits sensor data collected by the second sensor 210 of the second underwater sensor node 110 to the first underwater sensor node 106 over the established optical communication connection (step 430).

The first underwater sensor node 106 transmits sensor data collected by a first sensor 210 of the first sensor node 106 and the sensor data collected by the second sensor node 110 to a first buoyant platform 102 floating at a surface of a body of water 104 over a wired connection 108 using a wired transceiver 204 of the first underwater sensor node 106 and a wired transceiver 204 of the first buoyant platform 102 (step 435). A radio-frequency transceiver 202 of the first buoyant platform 102 transmits the sensor data collected by the first and second sensors 210 to a land-based radio-frequency base station 112 (step 440).

The communication of data from the land-based radio-frequency communication network 112 to the second underwater sensor node 110 will now be described in connection with FIG. 4B. The first buoyant platform 106 receives control data for the second underwater sensor node 110 from the land-based radio-frequency base station 112 (step 445). The wired transceiver 204 of the first buoyant platform 102 transmits the control data to the wired transceiver 204 of the first underwater sensor node 106 (step 450). The acoustic positioning system 212 of the underwater vehicle 114 is used to determine that the underwater vehicle 114 is within optical communication range of the first underwater sensor node 106 (step 455). A further optical communication connection is established between the first underwater sensor node 106 and the underwater vehicle 114 responsive to the determination that the underwater vehicle 114 is within optical communication range of the first underwater sensor node 106 (step 460). The first underwater sensor node 106 transmits the control data to the underwater vehicle 114 over the established further optical communication connection (step 465).

The acoustic positioning system 212 of the underwater vehicle 114 is used to determine that the underwater vehicle 114 is within optical communication range of the second sensor node 110 (step 470). Another optical communication connection is established between the second optical transceiver 206 of the second underwater sensor node 110 and the optical transceiver 206 of the underwater vehicle 114 responsive to the determination that the underwater vehicle 114 is within optical communication range of the second underwater sensor node 110 (step 475). The control data is transmitted from the underwater vehicle 114 to the second underwater sensor node 110 over the established another optical communication connection (step 480). The second underwater sensor node 110 processes the control data and adjusts operation of the second underwater sensor node 110 based on the processed control data (step 485).

The disclosed underwater wireless communication networks are particularly advantageous because, in some embodiments, the networks can operate completely autonomously to collect sensor data from the underwater sensor nodes and transmit the collected senor data from the water to land. Further, apart from the possibility of an operator on land designating the control data for the underwater sensor nodes, the transmission and distribution of control data can also be performed completely autonomously. The ability for the underwater wireless communication network to operate completely autonomously in connection with the self-powering of the water-based components (i.e., the buoyant platforms, the underwater sensor nodes, and the underwater vehicles) provides an underwater wireless communication network that can be deployed and not require additional visits to the water-based components to provide additional power to the water-based components (e.g., new batteries or recharging existing batteries) or for adjusting the operation of the water-based components, which, as described above, can be performed remotely from the land. This is particularly advantageous when the underwater wireless communication network is located far from land or deployed in a location that, although relatively close to land, is still located in an area that is difficult to reach.

The disclosed embodiments provide an underwater wireless communication system that uses optical communications to communicate between nodes and acoustic positioning for controlling when communications are exchanged between nodes. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] U.S. Patent Application Publication No. 2016/0134433, published May 12, 2016.

1. An underwater wireless communication network, comprising:
a first buoyant platform floating at a surface of a body of water and comprising a radio-frequency communication transceiver and a wired communication transceiver;
a first underwater sensor node coupled to the first buoyant platform by at least one wire over which the first buoyant platform and the first underwater sensor node communicate, wherein the first underwater sensor includes a wired communication transceiver to communicate with the first buoyant platform over the at least one wire, and wherein the first buoyant platform or the first underwater sensor node includes a first ambient energy collector configured to power the first buoyant platform or the first underwater sensor node; and
a second underwater sensor node under the body of water and comprising a second ambient energy collector configured to power the second underwater sensor node; and
wherein the first and second underwater sensor nodes each comprise a sensor, an optical communication transceiver, and an acoustic positioning system.

2. The underwater wireless communication network of claim 1, wherein the second underwater sensor node is under the body of water at a depth below a depth of the first underwater sensor node.

3. The underwater wireless communication network of claim 2, further comprising:
an underwater vehicle comprising an optical communication transceiver and an acoustic positioning system.

4. The underwater wireless communication network of claim 3, wherein the underwater vehicle is an autonomous underwater vehicle or a remote-controlled underwater vehicle.

5. The underwater wireless communication network of claim 1, further comprising:
a second buoyant platform floating at the surface of the body of water and comprising a radio-frequency communication transceiver and a wired communication transceiver; and
a third underwater sensor node coupled to the second buoyant platform by at least one wire over which the second buoyant platform and the third underwater sensor node communicate, wherein the third underwater sensor includes a third wired communication transceiver to communicate with the second buoyant platform over the at least one wire, and wherein the second buoyant platform or the third underwater sensor includes a third ambient energy collector.

6. The underwater wireless communication network of claim 5, further comprising:
an underwater vehicle comprising an optical communication transceiver and an acoustic positioning system.

7. The underwater wireless communication network of claim 6, wherein the underwater vehicle is an autonomous underwater vehicle or a remote-controlled underwater vehicle.

8. The underwater wireless communication network of claim 7, wherein the underwater vehicle is an autonomous underwater vehicle configured to follow a defined path between the first and second sensor nodes.

9. The underwater wireless communication network of claim 1, wherein the buoyant platform includes the second ambient energy collector.

10. The underwater wireless communication network of claim 1, wherein the first or second ambient collector is a solar panel, a wave energy collector, or tidal energy collector.

11. The underwater wireless communication network of claim 1, wherein the second energy ambient collector is an optical to electrical energy converter configured to receive optical energy from the first underwater sensor node and convert the received optical energy into electrical energy.

12. The underwater wireless communication network of claim 1, wherein the second underwater sensor node further comprises an electrical energy storage device.

13. A method for communicating using an underwater wireless communication network, the method comprising:
determining, using an acoustic positioning system, that a first underwater sensor node is within optical communication range of a second underwater sensor node;
establishing, responsive to the determination that the first underwater sensor node is within optical communication range of the second underwater sensor node, an optical communication connection between a first optical transceiver of the first underwater sensor node and a second optical transceiver of the second underwater sensor node;
transmitting sensor data collected by a second sensor of the second underwater sensor node to the first underwater sensor node over the established optical communication connection;
transmitting, by the first underwater sensor node, sensor data collected by a first sensor of the first underwater sensor node and the sensor data collected by the second sensor node to a first buoyant platform floating at a surface of a body of water over a wired connection using a wired transceiver of the first underwater sensor node and a wired transceiver of the first buoyant platform; and
transmitting, by a radio-frequency transceiver of the first buoyant platform, the sensor data collected by the first and second sensors to a land-based radio-frequency base station.

14. The method of claim 13, further comprising:
receiving, by the first buoyant platform from the land-based radio-frequency base station, control data for the second underwater sensor node;
transmitting, by the wired transceiver of the first buoyant platform to the wired transceiver of the first underwater sensor node, the control data;
determining, using the acoustic positioning system, that the first underwater sensor node is within optical communication range of the second underwater sensor node;
establishing, responsive to the determination that the first underwater sensor node is within optical communication range of the second underwater sensor node, a further optical communication connection between the first and second underwater sensor nodes;
transmitting, by the first underwater sensor node to the second underwater sensor node layover the established further optical communication connection, the control data; and
processing, by the second underwater sensor node, the control data and adjusting operation of the second underwater sensor node based on the processed control data.

15. The method of claim 13, further comprising:
receiving, by the second underwater sensor node from the first underwater sensor node, an optical signal;
converting, by an ambient energy collector in the second underwater sensor node, the received optical signal into electric energy; and
using the converted electric energy to power the second underwater sensor node during the transmission of sensor data from the second underwater sensor node to the first underwater sensor node.

16. The method of claim 13, further comprising:
converting, by an ambient energy collector in the second underwater sensor node, ambient energy into electric energy,
wherein the ambient energy is optical energy, tidal energy, or wave energy.

17. A method for communicating using an underwater wireless communication network comprising first and second underwater sensor nodes respectively comprising first and second optical transceivers, the method comprising:
determining, using an acoustic positioning system of an underwater vehicle, that the underwater vehicle is within optical communication range of the second sensor node;
establishing, responsive to the determination that the second underwater sensor node is within optical communication range of the underwater vehicle, an optical communication connection between the second optical transceiver of the second underwater sensor node and an optical transceiver of the underwater vehicle;
transmitting sensor data collected by a second sensor of the second underwater sensor node to the underwater vehicle over the established optical communication connection;
determining, using the acoustic positioning system of the underwater vehicle, that the underwater vehicle is within optical communication range of the first underwater sensor node;
establishing, responsive to the determination that the underwater vehicle is within optical communication range of the first underwater sensor node, an optical communication connection between the first optical transceiver of the first underwater sensor node and the optical transceiver of the underwater vehicle;
transmitting, by the underwater vehicle, sensor data collected by the second sensor of the second underwater sensor node to the first underwater sensor node over the established optical communication connection;
transmitting, by the first underwater sensor node, sensor data collected by a first sensor of the first sensor node and the sensor data collected by the second sensor node to a first buoyant platform floating at a surface of a body of water over a wired connection using a wired transceiver of the first underwater sensor node and a wired transceiver of the first buoyant platform; and
transmitting, by a radio-frequency transceiver of the first buoyant platform, the sensor data collected by the first and second sensors to a land-based radio-frequency base station.

18. The method of claim 17, further comprising:
receiving, by the first buoyant platform from the land-based radio-frequency base station, control data for the second underwater sensor node;
transmitting, by the wired transceiver of the first buoyant platform to the first wired transceiver of the first underwater sensor node, the control data;
determining, using the acoustic positioning system of the underwater vehicle, that the underwater vehicle is within optical communication range of the first underwater sensor node;
establishing, responsive to the determination that the underwater vehicle is within optical communication range of the first underwater sensor node, a further optical communication connection between the first underwater sensor node and the underwater vehicle;
transmitting, by the first underwater sensor node to the underwater vehicle over the established further optical communication connection, the control data;
determining, using the acoustic positioning system of the underwater vehicle, that the underwater vehicle is within optical communication range of the second sensor node;
establishing, responsive to the determination that the underwater vehicle is within optical communication range of the second underwater sensor node, another optical communication connection between the second optical transceiver of the second underwater sensor node and the optical transceiver of the underwater vehicle;
transmitting the control data from the underwater vehicle to the second underwater sensor node over the established another optical communication connection; and
processing, by the second underwater sensor node, the control data and adjusting operation of the second underwater sensor node based on the processed control data.

19. The method of claim 17, further comprising:
receiving, by the second underwater sensor node from the underwater vehicle, an optical signal;
converting, by an ambient energy collector in the second underwater sensor node, the received optical signal into electric energy; and
using the converted electric energy to power the second underwater sensor node during the transmission of sensor data from the second underwater sensor node to the underwater vehicle.

20. The method of claim 17, further comprising:
receiving, by the underwater vehicle from the first underwater sensor node, an optical signal;
converting, by an ambient energy collector in the underwater vehicle, the received optical signal into electric energy; and
using the converted electric energy to power the underwater vehicle.
